(19) United States
(12) Patent Application Publication
(10) Pub. No.: US 2001/0037209 A1
(43) Pub. Date: Nov. 1, 2001

(54) Pre-paid payment system and method for anonymous purchasing transactions

(76) Inventors: Greg Tarbutton, Newnan, GA (US); Ronald Chance, Tyrone, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 09/810,961

(22) Filed: Mar. 16, 2001

Related U.S. Application Data
(60) Provisional application No. 60/190,173, filed on Mar. 17, 2000.
(60) Provisional application No. 60/239,372, filed on Oct. 11, 2000.

(51) Int. Cl. G06F 17/60

(52) U.S. Cl. 705/1

(57) ABSTRACT

The present invention includes both a system and method for conducting anonymous transactions.

### CROSS REFERENCES TO RELATED APPLICATIONS

This application claims priority to provisional patent application Serial No. 60/190,173 and provisional patent application Serial No. 60/239,372, both of which are relied on and incorporated herein by reference.

### BACKGROUND OF THE INVENTION

Although the use of electronic payment systems is growing, several problems have not been adequately addressed by existing systems for conducting electronic purchasing transactions.

Currently, most electronic payment methods require the purchaser to use a credit, check or debit card to conduct the transaction. A purchaser must submit personal information to the vendor conducting the electronic transaction, including credit card number, fall name, card billing address, and shipping address. Privacy and security issues consequently arise as this information is made available over computer networks, such as the Internet, for verification purposes and to complete the transaction. Further, individuals who do not qualify for a credit card are unable to utilize e-commerce. As a result, a need exists for a system in which electronic payments can be made without providing personal information and which enables individuals who do not qualify for, or possess, traditional credit, debit or check cards.

The present invention answers this need by providing a pre-paid payment system that does not require personal information, is available for use by any individual, and is compatible with existing verification and purchasing systems of present credit, check, and debit card issuers and merchants.

### BRIEF SUMMARY OF THE INVENTION

The present invention relates to a system and method for conducting anonymous purchasing transactions. An aspect of the present invention includes an anonymous pre-paid payment card. The pre-paid payment card is made available to the public at retail establishments, but may also be purchased from the card issuer via an Internet website, telephone order, or other ordering methods.

The pre-paid payment card is provided with an anonymous name, such as a random sequence of alphanumeric characters, a card number that is compatible with existing electronic credit and debit systems, an expiration date, and a security personal identification number (PIN) code.

A further aspect of the invention is that any individual may purchase the pre-paid card and contact the pre-paid card issuer by telephone or an Internet site to activate the card and select a personal PIN code number. Once the card is activated, the card holder can utilize the card in a number of ways because the card is compatible with existing credit, check and debit card purchasing systems, such as VISA® or MASTERCARD®.

A further aspect of the present invention is that the card holder can contact the pre-paid card issuer to assign a delivery address to the pre-paid card. This address is preferably a location chosen by the card holder and is compatible with the verification systems of existing credit, check, and debit card purchasing systems.

In the preferred embodiment of the present invention, the pre-paid card may be used to conduct any electronic transaction, such as a point of sale, telephone, or online purchase. Because the verification system for the pre-paid card is compatible with one or more existing credit, check, or debit card systems, the card holder can provide the anonymous name, card number, card holder-assigned address information, and expiration date, to complete the transaction. Another aspect of the preferred embodiment of the present invention is that the pre-paid card is provided with a magnetic strip encoded for use as a traditional debit card. Upon making a purchase, the card holder enters the holder's PIN code for verification to complete the transaction.

Another aspect of the present invention is that all data associated with a pre-payment card and its respective user, which may include address information, pin code, card number, transaction information, anonymous name, and other user information, may be deleted based on pre-determined criteria.

### BRIEF DESCRIPTION OF THE DRAWINGS

FIG. 1 is a schematic illustration of an exemplary pre-paid payment card used in the present invention; and

FIG. 2 is a process flow diagram of an exemplary method of the present invention.

### DETAILED DESCRIPTION OF THE INVENTION

The present invention provides a system and method for conducting anonymous transactions with an anonymous pre-paid payment card.

In the preferred embodiment of the present invention, a payment card compatible with existing credit, check, and debit card systems is provided which is available for purchase by any individual. The payment card is provided with an amount designated by the pre-paid card issuer and is available for purchase at retail establishments or directly from the pre-paid card issuer.

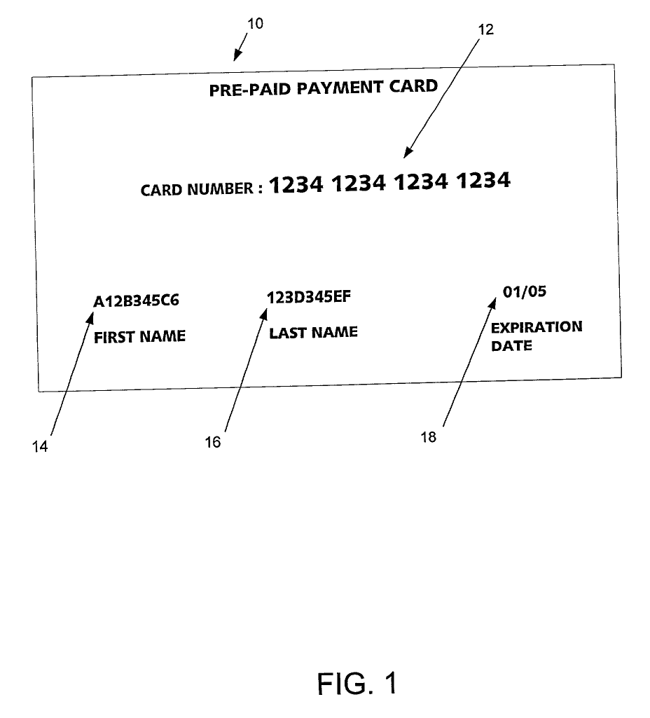

Referring to FIG. 1, the pre-paid payment card 10 is assigned a card/account number 12 compatible with existing credit, check and debit card purchasing systems, such as VISA® or MASTERCARD®. The payment card 10 of the present invention is further provided with an expiration date 18. The pre-paid payment card 10 is also provided with anonymous first name 14 and last name 16 on the card. The first name 14 and last name 16 are preferably a random sequence of alphanumeric characters.

Further, the pre-paid card is provided with a security code for activation purposes and to conduct traditional debit purchases at retail establishments. The security code is, for example, a four digit personal identification number (PIN) code randomly assigned to each issued pre-paid card 10 enabling the card holder to contact the pre-paid card issuer and change the security code to a PIN code that is individual to the card holder.

The card 10 is also provided with a magnetic strip encoded with account data that can be processed by electronic purchasing systems.

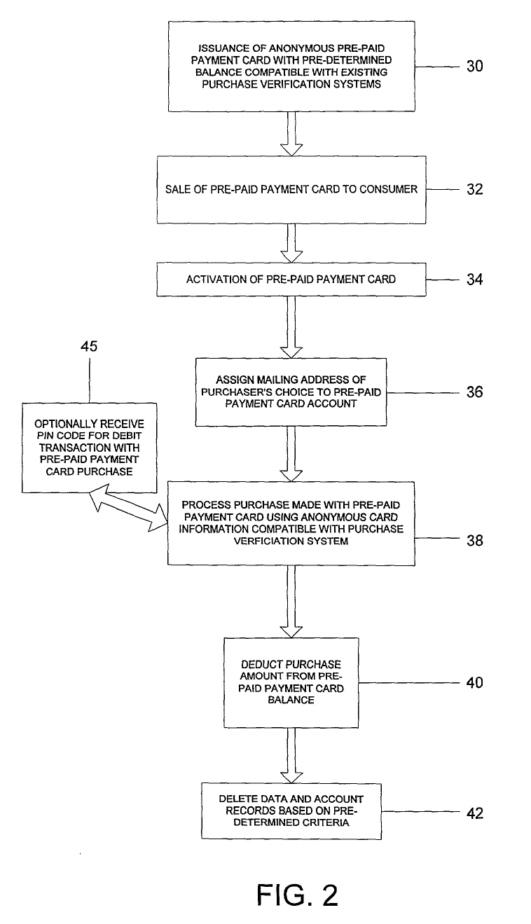

Referring to FIG. 2, a method for an anonymous payment transaction preferably includes an anonymous pre-paid payment card 10. At step 30, an account is issued by a card provider with a pre-determined balance. A corresponding pre-paid payment card 10 is issued with a card/account number 12 and anonymous first name 14 and last name 16 and an expiration date 18 compatible for processing by credit, check, and debit verification networks.

At step 32, a card purchaser purchases the pre-paid payment card 10 from a retail location. Those of ordinary skill in the art will appreciate that exemplary retail locations include traditional retail establishments, online orders, and telephone orders.

The pre-paid card 10 is purchased by an individual for said individual's own use or, alternatively, may be given to another as a gift. The pre-paid card is provided with a pre-determined debit amount limit.

The pre-paid card 10 is also provided with a website address, telephone number, facsimile number, or e-mail for contacting the pre-paid card issuer. The card holder contacts the card issuer to activate the card 10 at step 34.

Preferably, at step 34, the card holder activates the card 10 by providing the pre-assigned card number 12 and security code, and optionally the name information 14 and 16 and/or expiration date 18 on the card 10, to the card issuer. The card holder can select an individualized security code during the activation process.

Further, at step 36, the card holder assigns address information to the pre-paid card 10 such that verification of a transaction which requires such information is compatible with existing verification systems, such as VISA® or MASTERCARD®. The card holder can assign any delivery address to the pre-paid card 10, such as a post office box or other third party receiving agent, to protect privacy, while maintaining compatibility with present verification systems.

Once activated, the pre-paid payment card 10 is available for use by the card holder like a traditional debit, check, or credit card for electronic transactions.

The card holder, at step 38, uses the pre-paid card 10 for a purchase transaction via a telephone order or through a computer network, such as an e-commerce transaction via the Internet. Like traditional check and credit card systems, the pre-paid card holder provides the card number 12, first name 14 and last name 16, expiration date 18, and address information for verification and completion of the transaction. However, to preserve anonymity the pre-paid card holder provides the anonymous names 14 and 16 on the card and the individually assigned address information to the merchant. Because the pre-paid card information is compatible with the verification system of existing card issuers, the transaction is subsequently verified without the need for personal information.

After completion of the transaction, the purchase amount is deducted at step 40 from the corresponding pre-paid payment card account. It will be appreciated that the pre-paid card will not be approved for transactions that exceed the amount remaining on the pre-paid payment card account.

In an embodiment of the present invention, the magnetically encoded pre-paid payment card 10 can also be used as a traditional debit card at merchants supporting one or more verification systems with which the pre-paid payment card 10 is compatible, such as VISA® or MASTERCARD®. The magnetic strip is swiped, and the card holder enters the security code, such as a PIN code, at step 45 to complete the transaction. After successful verification at step 38, the purchase amount is subsequently subtracted from the pre-defined limit on the card 10 at step 40.

At step 42, any data associated with the card 10, the card user, and card transactions, is automatically deleted from any related databases, based upon pre-determined criteria. Such criteria may include pre-determined time after card is activated, pre-determined time since transaction exhausts card balance, pre-determined time from sale of card, an occurrence of a pre-determined event, or a combination of time and event criteria. Further, a card user may also request deletion of data records.

The deletion mechanism of the present invention provides improved security and privacy. By not retaining long-term data records, third parties have no way to access transaction information, card information (including activation numbers, randomly generated names, and amount), address information, pin code information, and other user-provided information. Further, the deletion of data records eliminates the need for a voluminous database, providing a more efficient data management system.

It will be appreciated by those skilled in the art that the system of the present invention is easily adapted to enable a card holder to add money to the pre-paid payment account, or transfer a remaining balance of an account to another pre-paid payment account.

It will further be appreciated by those skilled in the art that the present invention does not require a pre-qualification as do traditional credit and check cards, making the pre-paid payment card of the present invention readily accessible through retail establishments, online ordering, and the like, to any individual that wishes to conduct electronic transactions. Further, the present invention provides improved privacy and security over traditional debit, credit, and check cards. In addition, the present invention permits a pre-paid card to be used not only by the purchaser, but also able to be given as a gift.

While the invention has been described with reference to the structures and methods disclosed, it is not confined to the details set forth, but is intended to cover such modifications or changes as may fall within the scope of the following claims.

What is claimed is:

1. An anonymous pre-paid payment system comprising:
a) a payment card corresponding to a pre-paid account to be debited;
b) an account number assigned to said card and account;
c) an anonymous name assigned to said card;
d) an expiration date assigned to said card; and
e) a purchase verification processor for processing the account number to debit a purchase amount from the pre-paid account, wherein said purchase verification processor includes a credit card processing network.

2. The anonymous pre-paid system of claim 1 further comprising a mailing address selected by a cardholder to be assigned to the account.

3. The anonymous pre-paid payment system of claim 2 further comprising a magnetic strip encoded with the account number for processing by the verification processor during a purchase transaction.

4. The anonymous pre-paid payment system of claim 1 further comprising a magnetic strip encoded with the account number for processing by the verification processor during a purchase transaction.

5. The anonymous pre-paid payment system of claim 1 wherein said purchase verification processor processes the expiration date during a purchase transaction.

6. The anonymous pre-paid payment system of claim 5 wherein said purchase verification processor processes the anonymous name during a purchase transaction.

7. The anonymous pre-paid payment system of claim 1 further comprising a security code assigned to said card for account activation by a card holder.

8. The anonymous pre-paid payment system of claim 7, wherein said security code may be changed by a card holder.

9. The anonymous pre-paid payment system of claim 1, wherein said purchase verification processor processes a security code entered by a card holder during a purchase transaction.

10. The anonymous pre-paid payment system of claim 9 further comprising a magnetic strip encoded with the account number for processing by the verification processor during a purchase transaction.

11. A method for an anonymous purchase transaction comprising:
a) providing a debit account with a predetermined balance;
b) providing a pre-paid payment card with an account number corresponding to said account, wherein said payment card includes an expiration date and an anonymous name;
c) providing a security code associated with the debit account;
d) receiving a purchase amount request to debit said account;
e) verifying the purchase amount request over a credit card processing network; and
f) debiting the purchase amount request from the balance.

12. The method of claim 11 further comprising verifying the purchase amount request with the security code.

13. The method of claim 12 wherein said account information includes a card holder designated mailing address.

14. The method of claim 11 wherein said account information includes a card holder designated mailing address.

15. The method of claim 11 wherein said security code may be changed by a card holder.

16. The method of claim 15 further comprising receiving said security code to activate said card and account.

17. The method of claim 16 further comprising verifying the purchase amount with the security code.

18. The method of claim 17 further comprising deleting account information associated with said account based on pre-determined criteria.

19. The method of claim 11 further comprising deleting account information associated with said account based on pre-determined criteria.

20. The method of claim 13 further comprising deleting account information associated with said account based on pre-determined criteria.

21. The method of claim 15 wherein said account information includes a card holder designated mailing address.

22. A method for an anonymous purchase transaction comprising:
a) providing a debit account with a pre-determined balance;
b) providing a pre-paid payment card with an account number corresponding to said account, wherein said payment card includes an expiration date and an anonymous name;
c) receiving a purchase amount request to debit said account;
d) verifying the purchase amount request over a credit card processing network; and
e) debiting the purchase amount request from the balance.

23. The method of claim 22 further comprising verifying the purchase amount request with a security code.

24. The method of claim 23 wherein said account information includes a card holder designated mailing address.

25. The method of claim 22 wherein said account information includes a card holder designated mailing address.

26. The method of claim 22 further comprising deleting account information associated with said account based on pre-determined criteria.
